(19) United States
(12) Patent Application Publication
(10) Pub. No.: US 2024/0291655 A1
(43) Pub. Date: Aug. 29, 2024

(54) TRAINING ARIMA TIME-SERIES MODELS UNDER FULLY HOMOMORPHIC ENCRYPTION USING APPROXIMATING POLYNOMIALS

(71) Applicant: International Business Machines Corporation, Armonk, NY (US)

(72) Inventors: Allon ADIR, Kiryat Tivon (IL); Ramy MASALHA, Kafr Qari (IL); Eyal KUSHNIR, Kfar Vradim (IL); Ehud AHARONI, Kfar Saba (IL); Omri SOCEANU, Haifa (IL)

(21) Appl. No.: 18/173,648

(22) Filed: Feb. 23, 2023

(51) Int. Cl. H04L 9/30; H04L 9/00

(52) U.S. Cl. CPC H04L 9/3026; H04L 9/008

(57) ABSTRACT

An example system can include a processor to receive a ciphertext including a fully homomorphic encrypted (FHE) time series from a client device. The processor can train an ARIMA model on the ciphertext using an estimated error and approximating polynomials. The processor can generate an encrypted report and send the encrypted report to the client device.

### STATEMENT REGARDING GOVERNMENT-SPONSORED RESEARCH OR DEVELOPMENT

The project leading to this application has received funding from the European Union's Horizon 2020 research and innovation programme under grant agreement No. 10102193.

### BACKGROUND

The present techniques relate to time series models. More specifically, the techniques relate to training and executing encrypted time series models.

### SUMMARY

According to an embodiment described herein, a system can include processor to receive a ciphertext including a fully homomorphic encrypted (FHE) time series from a client device. The processor can also further train an ARIMA model on the ciphertext using an estimated error and approximating polynomials. The processor can also generate an encrypted model and send the encrypted model to the client device.

According to another embodiment described herein, a method can include receiving, via a processor, a fully homomorphic encryption (FHE) encrypted time series. The method can further include computing, under FHE, a predetermined number of differences based on a difference parameter of an ARIMA model to be used to model the FHE encrypted time series. The method can also further include computing, under FHE, model parameters for the ARIMA model using approximating polynomials. The method can also include outputting, via the processor, a trained model including the computed model parameters.

According to another embodiment described herein, a computer program product for training time-series models can include computer-readable storage medium having program code embodied therewith. The program code executable by a processor to cause the processor to receive a fully homomorphic encryption (FHE) encrypted time series. The program code can also cause the processor to compute, under FHE, a predetermined number of differences based on a difference parameter of an ARIMA model to be used to model the FHE encrypted time series. The program code can also cause the processor to compute, under FHE, model parameters for the ARIMA model using approximating polynomials. The program code can also cause the processor to output a trained model including the computed model parameters.

### BRIEF DESCRIPTION OF THE SEVERAL VIEWS OF THE DRAWINGS

FIG. 1 is a block diagram of an example computing environment that contains an example of an environment for the execution of at least some of the computer code involved in performing the inventive methods, such as a fully homomorphic encryption (FHE) optimized ARIMA time-series model module;

FIG. 2 is an example tangible, non-transitory computer-readable medium that can train and use an ARIMA time-series model under FHE for prediction;

FIG. 3 is a process flow diagram of an example method that can train ARIMA time-series models under FHE;

FIG. 4 is a process flow diagram of an example method that can predict future values using an ARIMA time-series model train according to embodiments described herein;

FIG. 5 is a process flow diagram of a detailed example method that can train ARIMA time-series models using approximating polynomials; and

FIG. 6 is a block diagram of an example system for training and using an ARIMA time-series model under FHE for prediction.

### DETAILED DESCRIPTION

Time series analysis is used to model sequences of values over time in order to predict a subsequent value in time. The autoregressive integrated moving average (ARIMA) model is one model used for time-series analysis. The value of a signal in an ARIMA at any point in time depends linearly on the values of the signal in the recent past, and on recent past deviations from the basic model, also referred to herein as errors. For example, a predicted value at time t Zₜ of an ARIMA model ARIMA(p=1,d=1,q=1) may be described using the equation:

$${Z}_{t} = μ + {φ}_{1} {Z}_{t - 1} + {θ}_{1} {ε}_{t - 1} + {ε}_{t} \qquad Eq . 1$$

where Zₜ₋₁ is a previous value, εₜ₋₁ is a previous error, εₜ is a current error, and p indicates the autoregressive (AR) order that describes how many units to look into the past when computing current signals, d indicates the degree of differencing (I) that describes the number of differentiations used to achieve a constant mean or average across time, and q the moving average (MA) order that indicates how many past errors to look at when computing current signals. For example, q is a unit of the time series that can be any unit of time, such as minutes, years, or even some non-uniform time step. Estimators are used to determine the values for p, d, and q before the model training can start. During training, the time-series Xₜ is received as input. A first difference Zₜ may be computed using the equation:

$${Z}_{t} = {X}_{t} - {X}_{t - 1} \qquad Eq . 2$$

The difference may be may be computed for all the received data points to generate a differentiated set of data points. Similarly, the d-th difference is computed if needed, based on the value of d. The coefficients μ,φ₁,θ₁ and the variance of εₜ may then be estimated. For example, for a large value of p, this may involve solving a system of equations. A prediction of a future value under encryption may then be performed. For example, the previous error terms εₜ may be estimated and Zₜ is then computed according to Eq. 1. In some cases, anomaly detection may be used if a prediction exceeds a threshold error.

In some cases, ARIMA models may be used under fully homomorphic encryption (FHE). For example, FHE can be used to implement various security schemes. For example, in one example, the data and model may be hidden from the training server. As another example, the prediction result from the ARIMA model may be hidden from the prediction server. However, training and prediction of such an ARIMA time-series model under fully homomorphic encryption (FHE) may be very inefficient. In particular, FHE only supports addition and multiplication. Therefore, other operations may need to be approximated in order to be executed under FHE. For example, such operations may be approximated using polynomials. Furthermore, FHE usually limits the multiplication depth that can be used efficiently in computations without requiring costly bootstrap operations. Also, FHE computations may accumulate numeric and cryptographic noise in the computed values, especially in deep computations. The multiplication depth of some calculations during ARIMA prediction may be as deep as the length of the series. Therefore, the execution of prediction on lengthy series may be very inefficient and noisy.

According to embodiments of the present disclosure, system can include a processor to receive a ciphertext including a fully homomorphic encrypted (FHE) time series from a client device. The processor can train an ARIMA model on the ciphertext using an estimated error and approximating polynomials. The processor can generate an encrypted report and send the encrypted report to the client device. For example, encrypted report may include encrypted parameters for the ARIMA model. Thus, embodiments of the present disclosure enable training and prediction with an ARIMA model under FHE by using FHE friendly computations for the training step, and by reducing the multiplication depth and homomorphic and estimation errors incurred during prediction under FHE. In particular, a server device can train and predict values using the ARIMA model without learning either the time-series data nor the resulting ARIMA model and prediction. Such trained ARIMA models may have various applications. For example, an ARIMA model may be trained on vehicle charging data and later used to detect anomalies in the charging patterns of vehicles at charging stations, among many other suitable applications.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as a fully homomorphic encryption (FHE) optimized ARIMA time-series model module 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

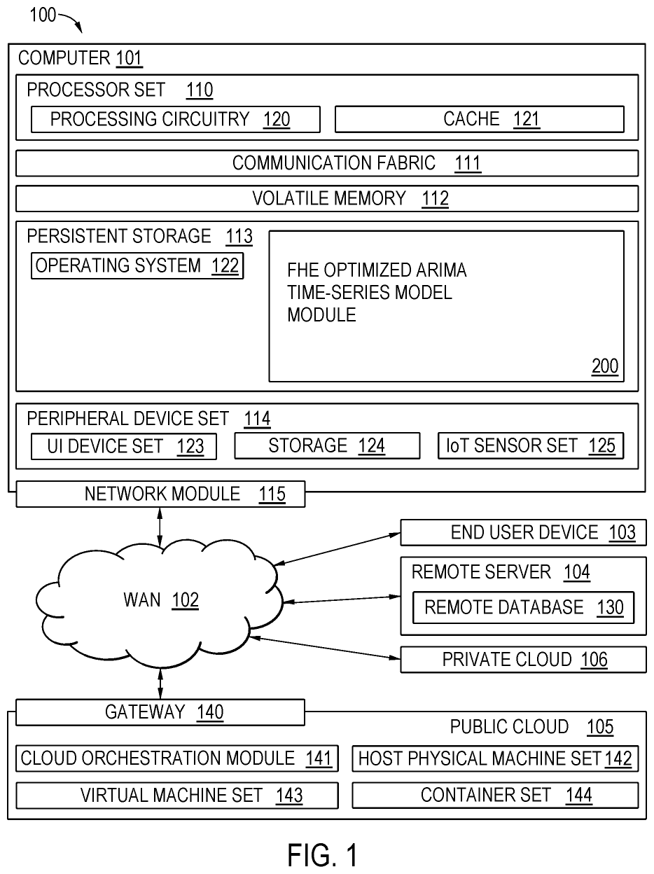

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

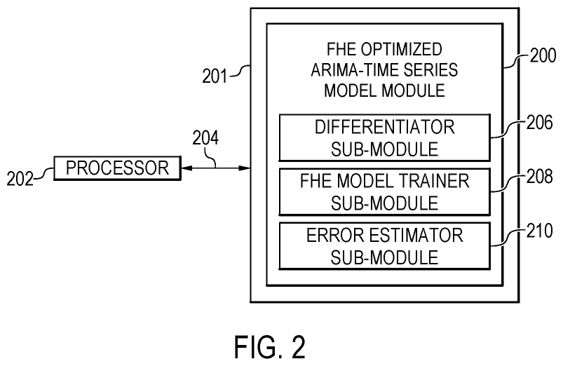

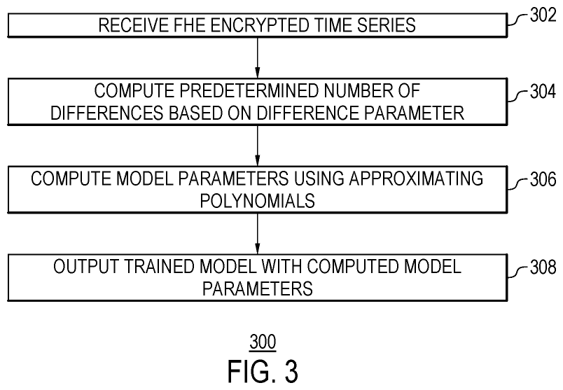

Referring now to FIG. 2, a block diagram is depicted of an example tangible, non-transitory computer-readable medium 201 that can train and use an ARIMA time-series model under FHE for prediction. The tangible, non-transitory, computer-readable medium 201 may be accessed by a processor 202 over a computer interconnect 204. Furthermore, the tangible, non-transitory, computer-readable medium 201 may include code to direct the processor 202 to perform the operations of the methods 300-500 of FIGS. 3-5.

The various software components discussed herein may be stored on the tangible, non-transitory, computer-readable medium 201, as indicated in FIG. 2. For example, the fully homomorphic encryption (FHE) optimized ARIMA time-series model module 200 may include a differentiator sub-module 206 that includes code to receive a fully homomorphic encryption (FHE) encrypted time series. The differentiator sub-module 206 also includes code to compute, under FHE, a predetermined number of differences based on a difference parameter of an ARIMA model to be used to model the FHE encrypted time series. The FHE optimized ARIMA time-series model module 200 may also include an FHE model trainer sub-module 208 that includes code to compute, under FHE, model parameters for the ARIMA model using approximating polynomials. The FHE model trainer sub-module 208 further includes code to output a trained model including the computed model parameters. The FHE model trainer sub-module 208 also includes code to compute a mean of the time series under FHE. In some examples, the FHE model trainer sub-module 208 also includes code to compute a variance of the times series under FHE based on the computed mean. In some examples, the FHE model trainer sub-module 208 also includes code to compute, under FHE, a covariance of time series values with corresponding values one entry into the past in the time series. In some examples, the FHE model trainer sub-module 208 also includes code to construct a number of equations with a number of unknowns using computed variance and covariance values, and solving the set of equations under FHE to compute a phi parameter (φ) of the ARIMA model. In some examples, the FHE model trainer sub-module 208 also includes code to compute a mu parameter of the ARIMA model using a mean of the time series and a computed phi parameter. In some examples, the FHE model trainer sub-module 208 also includes code to compute a residue series including residues of the time series and a series as predicted with computed mu and phi parameters, compute variance and covariance of the values in the residue series, and compute a theta parameters for the ARIMA model using the computed covariance values of the residue series. In some examples, the FHE model trainer sub-module 208 also includes code to compute, under FHE, an expected prediction error using a computed variance of the time series, a covariance of the time series, and a computed theta value for the ARIMA model. In some examples, FHE optimized ARIMA time-series model module 200 may also include an error estimator sub-module 210 includes code to compute an estimated error for the ARIMA model and predict a future prediction value for the FHE encrypted time series using the estimated error. The error estimator sub-module 210 also includes code to compute the estimated error using a partial subset of historical values in the FHE encrypted time series. In some examples, the error estimator sub-module 210 includes code to estimate the error during training using a number of partial subsets of recent values in the ciphertext, send a client device a number of associated encrypted predictions, and receive a selected partial subset of the number of partial subsets to use for training the ARIMA model.

FIG. 3 is a process flow diagram of an example method that can train ARIMA time-series models under FHE. The method 300 can be implemented with any suitable computing device, such as the computer 101 of FIG. 1. For example, the methods described below can be implemented by the processor set 110 of FIG. 1.

At block 302, a fully homomorphic encrypted time series is received. For example, the HE time series may be of length n and encrypted as an FHE ciphertext having multiple slots. In some examples, the ciphertext may be a CKKS ciphertext with 16K slots, which includes the time series values in the slots, in the order of the series.

At block 304, a predetermined number of differences are computed based on a difference parameter. For example, given a value of D=1, then a set of first order differences may be calculated. In some examples, given a value of D−2, then two sets, including a set of first order difference and a second set of second order differences, may be calculated. For example, the first set of differences is computed on the input series: Z₁(t)=X(t)−X(t−1). The 2nd set of differences is computed on the first set: Z₂(t)=Z₁(t)−Z₁(t−1), and additional sets of differences Z₃, Z₄, . . . , may similarly be computed if needed due to corresponding higher values of D in the model configuration. The training is then done on the last difference series. Thus, for example, if D=2 then the processor can compute Z₂ as shown above and forget about Z₁ and X during training. When predicting some future Z₂ value with the final trained model, the processor can use the Z₁ series again to compute the prediction in terms of Z₁ series. Then, from the Z₁ prediction and the original X series, the processor can compute the prediction in terms of the original X series, which is the original encrypted series that is to be used for prediction. Thus, in this example, the difference series Z₂ is used for training and the difference series Z₁ is used to create Z₂. In various examples, additional sets may be calculated for additional orders given greater values of D.

At block 306, model parameters are computed using approximating polynomials. For example, the model parameters μ, φ₁, θ₁ of Eq. 1 for an ARIMA(1,1,1) model may be computed using the approximating polynomials. For example, the coefficient φ₁ of Eq. 1 may be computed based on the equation:

$${φ}_{1} = Cov ( {Z}_{t} , {Z}_{t - 2} ) / Cov ( {Z}_{t} , {Z}_{t - 1} ) \qquad Eq . 3$$

where Cov(series1, series2) is the covariance of the given series. Similarly, the coefficient μ can be computed based on the equation:

$$μ = \overline{Z} * ( 1 - {φ}_{1} ) \qquad Eq . 4$$

where Z̅ is the mean of Z. Likewise, the coefficient θ₁ can be computed based on the equation:

$${θ}_{1} = ( 1 - \sqrt{1 - 4 {Corr ( {Y}_{t} , {Y}_{t - 1} )}^{2}} ) / 2 Corr ( {Y}_{t} , {Y}_{t - 1} ) \qquad Eq . 5$$

where Corr(series1, series2) is the correlation of the given series, and where the value of Yₜ can be computed based on the equation:

$${Y}_{t} = {Z}_{t} - ( μ + {φ}_{1} {Z}_{t - 1} ) \qquad Eq . 6$$

In addition, the variance of parameter Et can be calculated based on the equation:

$$Var ( {ε}_{t} ) = ( Cov ( {Z}_{t} , {Z}_{t - 1} ) - {φ}_{1} * Var ( {Z}_{t} ) ) / b \qquad Eq . 7$$

where Var(series) is the variance of the series values. In various examples, other more complex formulas may similarly be derived for other ARIMA models with higher values for p, d, q, though the complexity of the formulas rises with greater values for p and q. In various examples, different approximating polynomials may be used to execute the above functions under FHE. For example, for an encrypted vector V, the summation operation Sum(V) can be approximated using rotations and additions of input vector ciphertexts, as allowed by most FHE encryption schemes. In some examples, the averaging operation Mean(V) can be approximated by computing Sum(V) as described above and then computing a product with a plain value 1/N, as allowed by most FHE encryption schemes: Sum(V)*1/N. Similarly, in some examples, the variance operation Variance(V) may be approximated using the polynomial: Mean(V*V)−Mean(V)*Mean(V) (using subtraction and products allowed by most FHE encryption schemes). In addition, the covariance operation Covariance(Vₜ, Vₜ₋₁) can be approximated using the computation: Mean(V*rotate(V,1))−Mean(V)*Mean(V). Moreover, the correlation operation Correlation(Vₜ, Vₜ₋₁) can be approximated using the computation: Covariance(Vₜ, Vₜ₋₁)/Variance(V). Furthermore, provided a range of values for x in advance, the operation 1/X, √X can also be estimated with polynomials.

At block 308, a trained model with the computed model parameters is output. For example, the output trained model may include trained parameters μ,φ₁,θ₁ for Eq. 1.

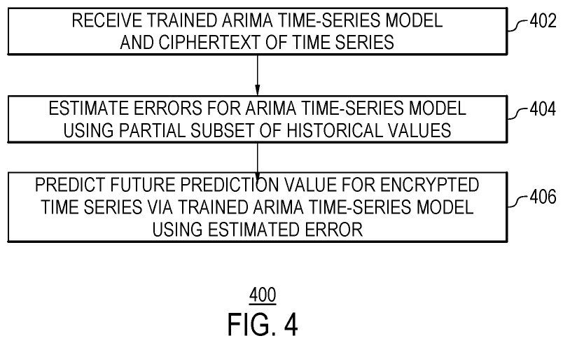

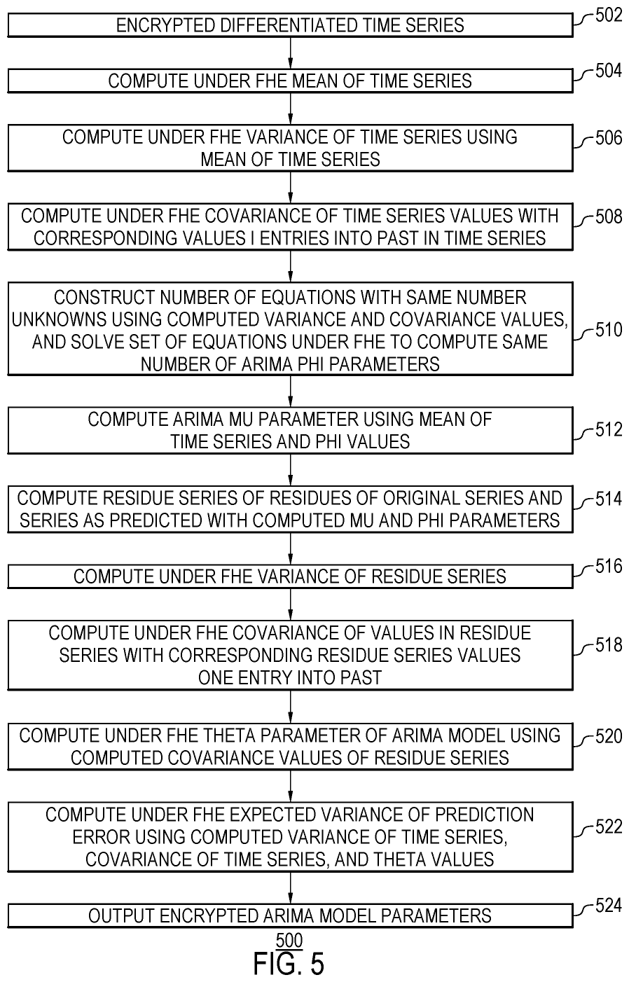

The process flow diagram of FIG. 3 is not intended to indicate that the operations of the method 300 are to be executed in any particular order, or that all of the operations of the method 300 are to be included in every case. Additionally, the method 300 can include any suitable number of additional operations. For example, the method 300 may also include any number of the operations described in the methods 400 and 500 of FIGS. 4 and 5.

FIG. 4 is a process flow diagram of an example method that can predict future values using an ARIMA time-series model trained according to embodiments described herein. The method 400 can be implemented with any suitable computing device, such as the computer 101 of FIG. 1. For example, the methods described below can be implemented by the processor set 110 of FIG. 1.

At block 402, a trained ARIMA time-series model and a ciphertext containing encrypted time-series values to be used for prediction are received. For example, the ARIMA model may have p, d, q parameters of 1, 1, 1.

At block 404, errors are estimated for the ARIMA time-series model using a partial subset of historical values. In some examples, the errors are estimated for the ARIMA time-series model using a suffix of the series containing the most recent values. As one example, the 15 most recently calculated values may be used to estimate the errors of the last 15 time steps. In various examples, a processor can thus start estimating the εᵢ just for the values of this partial subset. In particular, given the already trained values for μ,φ₁,θ₁, and ε₀=0, then:

$${\hat{Z}}_{1} = μ + {φ}_{1} {Z}_{0} + {θ}_{1} {ε}_{0} \qquad Eq . 8$$

$$and$$

$${ε}_{1} = {Z}_{1} - {\hat{Z}}_{1} \qquad Eq . 9$$

where Eq. 9 also holds for any time index i, such that εᵢ=Zᵢ−\hat{Z}ᵢ. The processor can continue to estimate all the εᵢ in the same manner, using the equation:

$${\hat{Z}}_{last + 1} = μ + {φ}_{1} {Z}_{last} + {θ}_{1} {ε}_{last} \qquad Eq . 10$$

The processor can then estimate the error of the predicted value last+1 using the time index generalization of Eq. 9, by calculating Zₗₐₛₜ₊₁−\hat{Z}ₗₐₛₜ₊₁. Calculating all the errors for the time series may be prohibitively expensive under FHE. For example, calculating a thousand errors in a times series with a thousand values under FHE may involve bootstrapping and thus be very inefficient and also introduce noise into the values. Therefore, instead of beginning at the first value of the time-series, the processor may begin this error estimation at the first of the last 15 values of the time-series, resulting in only 15 error calculations being made. In this manner, the processor can calculate the estimated error εₗₐₛₜ for the latest value εₗₐₛₜ. Alternatively, or in addition, the processor may calculate results for a number of possible partial series suffixes of various lengths. As one example, the processor may calculate estimated errors using sets of the last 10-20 values. The processor may thus calculate 11 corresponding expected errors as follows: for every n between 10 and 20, estimate the last error that corresponds to the last known value of the series and make this estimate based on the series suffix of length n. For each n, continue to predict the last known value of the time series. Finally subtract this predicted value from the actual known last value resulting in the actual last error for the value of n that was used. Thus, for each n we get the actual prediction error for the last known value, and we can consider this prediction error as the quality score of the specific n value (i.e. the length of the series suffix used to estimate the last error). In addition, for each n we predict the next unknown future value based on the series suffix and the errors that were estimated based on the series suffix of length n. This process results in 11 predictions for the next future value of the series along with 11 associated quality scores for these predictions. In various examples, the processor can then send the encrypted predictions to a user device. The user device can decrypt the results and a user may select the prediction with minimal expected error or a prediction with somewhat larger than optimal error but with a smaller n, to also optimize for product depth. For example, a number n may be selected by the user based on the accuracy of the prediction and the efficiency of using a number n with lower multiplication depth. The user of the user device may know the actual present value of the time series and compare each of the predictions as described in the above process. As one example, the user may then select the prediction with accuracy that exceeds some threshold and also has the least multiplication depth. For example, the user may decide on a threshold accuracy and targeted depth and configure the system including the processor with these two parameters. In both of these manners, the method 400 may overcome the technical problem that multiplication depth is as deep as the length of the series by reducing the length of the series used for error estimation of εₗₐₛₜ.

At block 406, a future prediction value is predicted for the encrypted time series via the trained ARIMA time-series model using the estimated errors. For example, the processor can calculate Zₜ of Eq. 1, in this case, Zₜ being the predicted future value of the encrypted time series, using the computed encrypted parameters for the ARIMA model and the estimated errors. In various examples, the future predicted value is encrypted and may be sent to a client device to be decrypted and analyzed. In some examples, the client device may use the predicted value to detect one or more anomalies.

The process flow diagram of FIG. 4 is not intended to indicate that the operations of the method 400 are to be executed in any particular order, or that all of the operations of the method 400 are to be included in every case. Additionally, the method 400 can include any suitable number of additional operations. For example, given an ARIMA model with a p value other than 1, the following formula may alternatively be used:

$${Z}_{t} = μ + {φ}_{1} {Z}_{t - 1} + {φ}_{2} {Z}_{t - 2} + … + {φ}_{n} {Z}_{t - n} + {θ}_{1} {ε}_{t - 1} + {ε}_{t} \qquad Eq . 11$$

Moreover, given n=2, other formulas may be used for estimating variables and values μ, φ₁, φ₂, θ₁, Var(εₜ). In some examples, for ARIMA models with a p value of n>3 a system of n equations with n unknowns may be used to learn φ₁, φ₂, . . . , φn. In these examples, the value of μ can be calculated using the equation:

$$μ = MEAN ( {Z}_{t} ) * ( 1 - {φ}_{1} - {φ}_{2} … - {φ}_{n} ) \qquad Eq . 12$$

Yₜ can be computed based on the equation:

$${Y}_{t} = {Z}_{t} - ( μ + {φ}_{1} {Z}_{t - 1} + {φ}_{2} {Z}_{t - 2} + … + {φ}_{n} {Z}_{t - n} ) \qquad Eq . 13$$

where Yₜ is an MA(1) model, and therefore the processor can learn θ₁ as before. In various examples, the processor can also estimate Var(εₜ) with similar formulas for any value of n. In some examples, a system of n equations with n unknowns under FHE may be solved using Cramer's rule, where n+1 determinants are first computed and then n divisions are executed to solve the n variables, according to the equation:

$${x}_{i} = \frac{det ( {A}_{i} )}{det ( A )} \qquad Eq . 14$$

where xᵢ is the individual value of each unknown and A is an n×n matrix that has a nonzero determinant.

FIG. 5 is a process flow diagram of a detailed example method that can train ARIMA time-series models using approximating polynomials. The method 500 can be implemented with any suitable computing device, such as the computer 101 of FIG. 1. For example, the methods described below can be implemented by the processor set 110 of FIG. 1. The method 500 can be used to train a (P, D, 1) ARIMA model, where P and D are equal to or greater than one.

At block 502, an encrypted differentiated time series is received. For example, a times series S may be an encrypted and differentiated sequence of data points listed in time order.

At block 504, a mean of the time series is computed under fully homomorphic encryption (FHE). For example, a mean Mean(S) may be computed as the mean of encrypted differentiated time series S under FHE by computing a sum of an encrypted vector representing time series S and then computing a product with a plain value 1/N, as described above. In various examples, this may be performed by repeated rotation and adding as described herein.

At block 506, a variance of the encrypted differentiated time series is computed under FHE using the means of the encrypted differentiated time series. In various examples, a variance Variance(S) is computed as the variance of series S using Mean(S) under FHE as described above. For example, the variance of the encrypted differentiated time series S can be approximated using the computation: Mean(S*S)−Mean(S)*Mean(S) computing the Means as described above and then using subtraction and products allowed by most FHE encryption schemes.

At block 508, a covariance of the encrypted differentiated time series values is computed under FHE as a covariance of encrypted differentiated time series values with corresponding values entries into the past in the time series. For example, the covariance Covariance(S, S−i) may be computed as the covariance of the values of series S with corresponding values i entries into the past in S. As one example, Covariance(Sₜ, Sₜ₋₁) can be approximated using the computation: Mean(S*rotate(S, 1))−Mean(S)*Mean(S). In various examples, the Covariance(S, S−i) may be computed repeatedly for all entries i in the range of [1, p+1].

At block 510, a number of equations may be constructed with the same number of unknowns using the computed variance and covariance values. The set of equations may then be solved under FHE to compute the same number of ARIMA phi parameters. For example, a processor can construct a set of p equations with p unknowns using the above computed variance and covariance values. The processor can then solve the set of equations under FHE to compute the P ARIMA phi parameters. For example, the set of equations may be solved using Cramer's method.

At block 512, an ARIMA mu parameter is computed using the mean of the time series and the phi values as described in Eq 12. For example, a processor can compute the ARIMA Mu parameter using the Mean(S) and phi values calculated in blocks 502 and 510.

At block 514, a residue series is computed as a residue of the original series and a series as predicted with the computed mu and phi parameters. For example, a processor can compute the residue series R of residues of the original time series S and a series as predicted with the above computed mu and phi parameters from blocks 510 and 512. In various examples, the residue series may be computed using Eq. 13 as describe above.

At block 516, a variance of the residue series is computed under FHE. For example, the processor can compute the variance of residue series R under FHE.

At block 518, a covariance of values in the residue series with corresponding residue values one entry into the past is computed under FHE. For example, the processor can compute under FHE a CovarianceR−1 as the covariance of values in residue series R with corresponding R values that are each one entry into the past from each of the values in the residue series R.

At block 520, a theta parameter for the ARIMA model is computed under FHE using the computed covariance values of the residue series. For example, the processor can use the above computed covarianceR−1 from block 518 to compute, under FHE, the theta parameter of the ARIMA model. In various examples, computing the theta parameter includes computing a square-root and a reciprocal under FHE using appropriate estimating polynomials.

At block 522, an expected variance of the prediction error is computed under FHE using the computed variance of the time series, the covariance of the time series, and the theta values. For example, the processor may use the above computed varianceS, covariance(S, S−i) and theta values to compute the expected prediction error under FHE.

At block 524, a set of encrypted model parameters are output for the ARIMA model. For example, the set of encrypted model parameters may include encrypted mu, phi, and expected prediction error parameters, as shown in Eq. 1, as well as the variance of the error.

The process flow diagram of FIG. 5 is not intended to indicate that the operations of the method 500 are to be executed in any particular order, or that all of the operations of the method 500 are to be included in every case. Additionally, the method 500 can include any suitable number of additional operations.

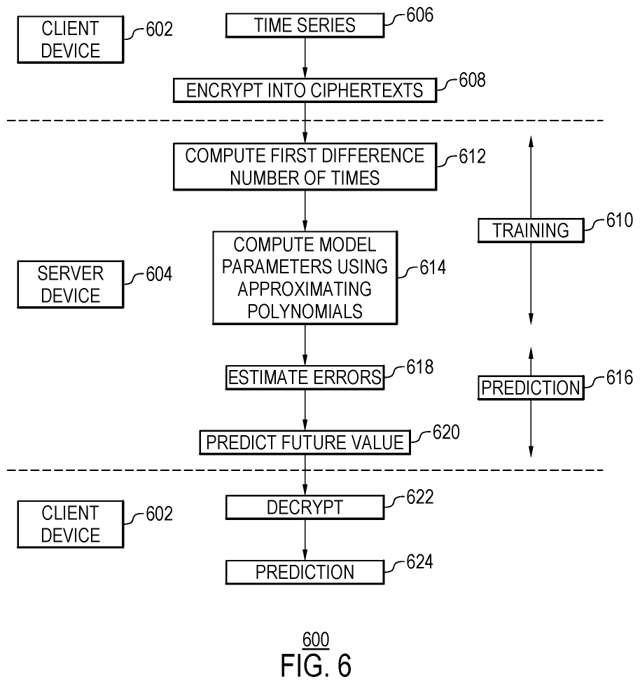

With reference now to FIG. 6, a block diagram shows an example system for training and using an ARIMA time-series model under FHE for prediction. The example system 600 of FIG. 6 includes a client device 602 and a server device 604. For example, the client device 602 may be communicatively coupled to the server device 604. For example, the server device 604 may be the computer 101 of FIG. 1. The system 600 further includes a time series 606. In the example of FIG. 6, the system 600 can train and execute inference with an ARIMA model ARIMA(d=1, p=1, q=1).

At block 608, the client device 602 encrypts the time series 606 into a number of ciphertexts. For example, the time series 606 may be encrypted using FHE into one or more ciphertexts. The client device 602 then sends the ciphertexts to the server device 604 to use for training a time-series model. As one example, the time series being analyzed may be represented as Z(t), which is assumed to contain n values indexed [0,n−1]. Z(t) may also be referred to as ciphertext Z where Z[i] is the n'th slot containing the n'th value in the series Z(t). In various examples, the system 600 may receive as input the encrypted time series of length n as an FHE ciphertext with multiple slots. For example, the FHE ciphertext may be a CKKS ciphertext with 16K slots, which includes the time series values in the slots, in the order of the series.

At block 610, the server device 604 receives the ciphertexts and begins a training process 610. For example, the server device 604 can compute a first difference a number of times. For example, the first difference may be computed between each adjacent pair of ciphertexts to generate a differentiated time series. For example, the difference may be computed using Eq. 2. In the example of FIG. 6, the system 600 trains an ARIMA model with a d of d=1. If d=1, then the system 600 computes ZD1=rotate(Z,1)−Z, where ZD1 contains the “1st difference” series of length n−1 and the last slot is ignored, and where the operation rotate(X, n) indicates that a ciphertext X is rotated n slots to the left.

Still referring to FIG. 6, at block 612, the server device 604 can then use the differentiated series Z=ZDd of length n-d for training and inference. Z, as used herein, refers to either X, Z1, Z2, . . . depending on the value of D, which is 1 in the specific example of FIG. 6. For example, at block 614, the service device 604 computes model parameters using approximating polynomials. For example, the server device 604 can evaluate various statistical metrics under FHE, including mean, variance, covariance, and correlation, as described in detail above. As one example, given a ciphertext X with L slots, the service device 604 can compute mean(X) by summing the slots by repeated rotation and adding and finally dividing by the constant plain value L. The result is duplicated in all the slots. Similarly, the server device 604 can compute variance(X) as mean(X*X)−mean(x)*mean(X), where * is element-wise multiplication of two ciphertexts via the FHE product operation and mean(X) is computed as described above. The result is duplicated in all the slots. Likewise, in various examples, the server device 604 can compute the covariance(X, Y), referring to the covariance of the corresponding slots in the two ciphertexts X and Y. The server device 604 can compute the covariance(X,Y) as mean(X*Y)−mean(X)*mean(Y). Again, the result is duplicated in all the slots. In some examples, the server device 604 can calculate correlation(X(i), X(i−1)), which is the Pearson correlation between the slots with respect to the previous slots. For example, this equals covariance(X(t), X(t−1))/variance(X). In various examples, the dividend and divisor can be computed and duplicated in all the slots of two separate ciphertexts, and the division can be computed under FHE as follows: to compute the division under FHE C₁/C₂ for ciphertexts C₁ and C₂, the server device 602 can compute 1/C₂ with a polynomial estimating 1/X and then multiply the result with C₁.

As described with respect to Eq. 1, if the order of the autoregression (AR) part of the ARIMA model is 1 and the order of the moving average (MA) part is 1, then the ARIMA(d=1, p=1, q=1) model is of the form Z(t)=μ+A*Z(t−1)+B*err(t−1)+err(t), where Z(t−j) is a time series created from Z(t) by moving the values j slot earlier so that slot i of Z(t−j)=slot i+j of Z(t). In particular, if Z(t) is of length n, then Z(t−j) is of length n-j. In various examples, the server device 602 may use the least squares solution to obtain the following parameters: A=covariance(Z(t), Z(t−2))/covariance(Z(t), Z(t−1)) and μ=mean(Z)*(1−A). In addition, the server device 604 can define a new series: Y(t)=Z(t)−(μ+A*Z(t−1)), with B=(1−sqrt(1−4*correlation(Y(t), Y(t−1))\hat{ }2))/2*correlation(Yt, Y(t−1)). In various examples, similar, more complex, formulas can be derived and used for other low ARIMA models.

In various examples, the server device 604 can then compute model parameters A and B. For example, parameter A can be computed using Eq. 3 above as, A=covariance(Z(t), Z(t−2))/covariance(Z(t), Z(t−1)). In particular, the two covariances in this expression can be computed and duplicated in all the slots according to the above described method for computing covariance. The division can be computed under FHE as described above. The value A is now duplicated in all the slots.

The server device 604 can then compute u=mean(Z)*(1-A), based on Eq. 3 above. For example, the server device 604 can compute mean(Z) and A and duplicate them in all the slots as describe above. Finally, the server device 604 can multiply the two results under FHE and the value μ is duplicated in all the slots.

The server device 604 can then compute Y(t)=Z(t)−(μ+A*Z(t−1)), based on Eq. 6 above. The ciphertext representation of Z(t−1) is multiplied by A and the added to μ, where A and μ were computed above, so as to be duplicated in all the slots. In various examples, the resulting ciphertext is subtracted from Z to produce the encrypted sequence Y.

The server device 604 can then compute B=(1−sqrt(1−4*correlation(Y(t), Y(t−1))\hat{ }2))/2*correlation(Yt, Y(t−1)), where correlation(Y(t), Y(t−1)) as described above. The constants in the above expression (1, 2, 4) are represented as plaintexts where the value is duplicated in all the slots. The * and − operations are done via the corresponding FHE element-wise operations and the \hat{ }2 operation is executed by multiplying the intermediate ciphertext by itself. The sqrt operation is computed using an estimating polynomial. The division is computed as described above, also with an estimating polynomial.

In various examples, the server device 604 can also execute an inference process to perform a prediction 616. For example, after the training 610 above, the service device 604 may have the encrypted values μ, A and B of the ARIMA(d=1, p=1, q=1) model for the equation Z(t)=u+A*Z(t−1)+B*err(t−1)+err(t), according to Eq. 1. Note that if Z is a series of n values (Z[0:n−1]) then Z(t−1) is a series of n−1 values because the last value in Z(t−1) is ignored. The next (future) value of the series can be predicted using Eq. 2 as Z(n)=u+A*Z(n−1)+B*err(n−1), which would predict Z(n) with unknown small error err(n). However in order to predict Z(n) according to Eq. 2, the value err(n−1) must first be known. At block 618, the server device 604 can therefore estimate errors. For example, one possible method of doing this is to estimate err(n−1) according to the following Algorithm:

$$for a given time - series Z [ 0 : n - 1 ] of length n : \\ 1. assume err ( 0 ) = 0 \\ 2. for i in [ 1 , n - 1 ] : \\ 3. compute err ( i ) = Z ( i ) - ( u + A * Z ( i - 1 ) + B * err ( i - 1 ) ) \\ 4. predict Z ( n ) = u + A * Z ( n - 1 ) + B * err ( n - 1 ) \qquad Algorithm 1$$

However, computing the above under FHE is problematic because the multiplication depth of the final err(n−1) is n−1, or the length of the series, which may be very long may thus incur many bootstraps and much homomorphic noise. Assuming that the desired product depth is m<n, the above algorithm may instead be replaced with the following algorithm:

$$for a given time - series Z [ 0 : n - 1 ] of length n : \\ 1. assume err ( n - m - 1 ) = 0 \\ for i in [ n - m , n - 1 ] : \\ 3. compute err ( i ) = Z ( i ) - ( u + A * Z ( i - 1 ) + B * err ( i - 1 ) ) \\ 4. predict Z ( n ) = u + A * Z ( n - 1 ) + B * err ( n - 1 ) \qquad Algorithm 2$$

where the err(n−1) resulting from algorithm 2 is somewhat less accurate than the err(n−1) resulting from algorithm 1, but incurs a multiplication depth of m<n rather than n−1. In various examples, if m is too low, then err(n−1) and the prediction error err(n) may be too high. On the other hand, if m is too high, then the homomorphic noise may become too large. However, the accuracy of the resulting err(n−1) was found to be good even with a small m. For example, for a n=16K and m=15 the resulting error in err(n−1) was quite small. Therefore, the following algorithm may be used to allow the user to select the best estimate among estimates computed using values of m in the range [M1, M2]:

$$for a given time - series Z [ 0 : n - 1 ] of length n : \\ 1. for m in [ M 1 , M 2 ] : \\ 2. assume err ( n - m - 1 ) = 0 \\ 4. for i in [ n - m , n - 1 ] : \\ 5. compute err ( i ) = Z ( i ) - ( u + A * Z ( i - 1 ) + B * err ( i - 1 ) ) \\ 6. predict Z ( n ) = u + A * Z ( n - 1 ) + B * err ( n - 1 ) \\ 6. “ predict ” the known Z ( n - 1 ) as \\ \hat{Z} ( n - 1 ) = u + A * Z ( n - 2 ) + B * err ( n - 2 ) \\ 7. send to the user : \\ m \\ prediction Z ( n ) \\ estimated error of prediction : \hat{Z} ( n - 1 ) - Z ( n - 1 ) \qquad Algorithm 3$$

The user can decrypt the above Z and \hat{Z} values for the various multiplication depths m, and select the prediction with the least estimated error. Again, lowering m would reduce the homomorphic noise but increase the error in the estimated err(n−1). Therefore, the user may select a balanced value for m where the overall estimated error is minimal. For example, the user device can decrypt the results and a user may select the prediction with minimal expected error or a prediction with somewhat larger than optimal error but with a smaller m, to also optimize for product depth. A number m may be selected by the user based on the accuracy of the prediction and the efficiency of using a number m with lower multiplication depth. In some examples, the user may also wish to involve consideration of minimizing the product depth if the resulting prediction is to be used in further homomorphic computations. For example, select predictions with multiplication depth m values may thus be somewhat smaller than in the balanced value, which still have a small enough error penalty.

At block 622, the client device 602 decrypts received encrypted predictions 620 to generate predictions 624. For example, the client device 602 can decrypt the encrypted predictions 620 using the key that was used to encrypt the time series 606 at block 608.

It is to be understood that the block diagram of FIG. 6 is not intended to indicate that the system 600 is to include all of the components shown in FIG. 6. Rather, the system 600 can include fewer or additional components not illustrated in FIG. 6 (e.g., additional degrees of differentiation, different ARIMA model values of d and p, or additional client devices, server devices, etc.). For example, if d=2 then the server device 602 can also compute ZD2=rotate(ZD1,1)−ZD1, where ZD2 contains the “2nd difference” series of length n−2 and the last 2 slots are ignored. ZDd can thus be similarly computed recursively for any d as ZDd=ZD(d−1)−rotate(ZD(d−1), 1). In various examples, the system 600 can be extended to higher values of d, p, q, than the values of 1, 1, 1 used in the example of FIG. 6 but may work more efficiently with lower values of p and q, with the lowest value being 1.

The descriptions of the various embodiments of the present techniques have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising a processor to:
receive a ciphertext comprising a fully homomorphic encrypted (FHE) time series from a client device;
train an ARIMA model on the ciphertext using an estimated error and approximating polynomials; and
generate an encrypted model and send the encrypted model to the client device.

2. The system of claim 1, wherein the processor is to estimate the error for training the ARIMA model using a partial subset of recent values in the ciphertext.

3. The system of claim 2, wherein the processor is to estimate the error during training using a plurality of partial subsets of recent values in the ciphertext, send the client device a plurality of associated encrypted predictions, and receive a selected partial subset of the plurality of partial subsets to use for training the ARIMA model.

4. The system of claim 1, wherein the encrypted model comprises encrypted parameters for the ARIMA model.

5. The system of claim 1, wherein the processor is to compute a predetermined number of differences based on a difference parameter of the ARIMA model.

6. The system of claim 1, wherein the ARIMA model comprises a moving average (MA) order having a value of one.

7. The system of claim 1, wherein the ciphertext is encrypted under fully homomorphic encryption, and the ARIMA model is trained and the encrypted model generated under fully homomorphic encryption.

8. A computer-implemented method, comprising:
receiving, via a processor, a fully homomorphic encryption (FHE) encrypted time series;
computing, under FHE, a predetermined number of differences based on a difference parameter of an ARIMA model to be used to model the FHE encrypted time series;
computing, under FHE, model parameters for the ARIMA model using approximating polynomials; and
outputting, via the processor, a trained model comprising the computed model parameters.

9. The computer-implemented method of claim 8, further comprising computing, via the processor, an estimated error for the ARIMA model and predicting, via the processor, a future prediction value for the FHE encrypted time series using the estimated error.

10. The computer-implemented method of claim 9, wherein computing the estimated error comprises using a partial subset of historical values in the FHE encrypted time series.

11. The computer-implemented method of claim 9, wherein computing the estimated error comprises estimating, via the processor, the error during training using a plurality of partial subsets of recent values in a ciphertext, sending a client device a plurality of associated encrypted predictions, and receiving a selected partial subset of the plurality of partial subsets to use for training the ARIMA model.

12. The computer-implemented method of claim 8, wherein computing the model parameters comprises computing a mean of the FHE encrypted time series under FHE.

13. The computer-implemented method of claim 12, wherein computing the model parameters comprises computing a variance of the FHE encrypted times series under FHE based on the computed mean.

14. The computer-implemented method of claim 8, wherein computing the model parameters comprises computing, under FHE, a covariance of time series values with corresponding values one entry into the past in the FHE encrypted time series.

15. The computer-implemented method of claim 8, wherein computing the model parameters comprises constructing a plurality of equations with a plurality of unknowns using computed variance and covariance values, and solving a set of equations under FHE to compute a phi parameter of the ARIMA model.

16. The computer-implemented method of claim 8, wherein computing the model parameters comprises computing a mu parameter of the ARIMA model using a mean of the FHE encrypted time series and a computed phi parameter.

17. The computer-implemented method of claim 8, wherein computing the model parameters comprises computing a residue series comprising residues of the FHE encrypted time series and a series as predicted with computed mu and phi parameters, computing variance and covariance of values in the residue series, and computing a theta parameters for the ARIMA model using the computed covariance values of the residue series.

18. The computer-implemented method of claim 8, wherein computing the model parameters comprises computing, under FHE, an expected prediction error using a computed variance of the FHE encrypted time series, a covariance of the FHE encrypted time series, and a computed theta value for the ARIMA model.

19. A computer program product for, the computer program product comprising a computer-readable storage medium having program code embodied therewith, the program code executable by a processor to cause the processor to:
receive a fully homomorphic encryption (FHE) encrypted time series;
compute, under FHE, a predetermined number of differences based on a difference parameter of an ARIMA model to be used to model the FHE encrypted time series;
compute, under FHE, model parameters for the ARIMA model using approximating polynomials; and
output a trained model comprising the computed model parameters.

20. The computer program product of claim 19, further comprising program code executable by the processor to compute an estimated error for the ARIMA model and predict a future prediction value for the FHE encrypted time series using the estimated error.
